(19) United States
(12) Patent Application Publication
(10) Pub. No.: US 2025/0117345 A1
(43) Pub. Date: Apr. 10, 2025

(54) METHOD FOR COMMUNICATING DATA BETWEEN A SLAVE DEVICE AND A MASTER DEVICE, AND CORRESPONDING INTEGRATED SYSTEM

(71) Applicant: STMicroelectronics International N.V., Geneva (CH)

(72) Inventors: Alexis NAI, Aix en Provence (FR); Joel CURTET, Saint-Paul de Varces (FR)

(21) Appl. No.: 18/897,783

(22) Filed: Sep. 26, 2024

(30) Foreign Application Priority Data
Oct. 10, 2023 (FR) 2310823

(51) Int. Cl. G06F 13/20

(52) U.S. Cl. CPC G06F 13/20; G06F 2213/40

(57) ABSTRACT

The present disclosure provides a method for communicating data between a slave device and a master device according to a communication protocol. An example includes the data being recorded in a memory belonging to the slave device, the method comprising a generation by the master device of a command provided by the communication protocol, and use of a field of the command in order to select an indirection register belonging to the slave device and containing an address of a region of the memory including the data.

### CROSS REFERENCE TO RELATED APPLICATION(S)

This application claims the priority benefit of French patent application number FR2310823, filed on Oct. 10, 2023, entitled “Procede De Communication De Donnees Entre Un Dispositif Esclave Et Un Dispositif Maitre, Et Systeme Integre Correspondant,” which is hereby incorporated by reference to the maximum extent allowable by law.

### TECHNICAL FIELD

Embodiments and implementations relate to data communication methods in an integrated system, in particular communications following the “SDIO” standard for “Secure Digital Input Output” defined by the “SD Association” group.

### BACKGROUND

“SDIO” type communication between a master device and a slave device is conventionally carried out using commands specific to the standard.

SDIO commands are defined by the standard and contain fixed fields, intended to contain useful information such as an indication of the type of command (a “command index”), a function number, the address of the read/write data to be transferred, etc.

The SDIO standard allows in particular a possibility of 8 functions. Function 0 is reserved to implement the standard. Functions 1 to 7 are free. Each function can be mapped into its own memory space.

The standard allows a 17-bit address field for direct and extended read/write commands (usually “IO_RW_DIRECT” and “IO_RW_EXTENDED” respectively). This limits the address range to 128 kB (kilo Bytes).

Even using the 7 functions, the range of 128 kB*7=896 kB is not sufficient for use cases of slave device functionalities, such as for example for sending and receiving data packets, placed in a memory of the slave device implementing WiFi type communication.

In order to increase the size of the address range accessible in the memory with SDIO commands, it has been proposed to use a linked list of descriptors in the memory of the slave device. However, this previous solution has the disadvantages of not being able to program the linked list by the master device, nor to control the address range by the master device, and of being limited in volume by transmissions, for example limited to 128 kB per transmission.

There is thus a need to benefit from greater flexibility in SDIO communications, in particular to allow larger transfers.

### BRIEF SUMMARY

Aspects and implementations and embodiments defined below propose indirect addressing via an indirection register, allowing direct memory access channel type access, so that a single read or write command can reach any region of the memory (for example up to 1 MB) anywhere in the memory (for example 4 GB).

Furthermore, the indirection register can be configured by the master device, so as to benefit from a functionality adapted to the needs and capacity of the master device on the one hand, or by the slave device, so as to be able to impose security measures, such as firewall type filtering, in the access to the memory on the other hand.

According to one aspect, provision is made in these respects of a method for communicating data between a slave device and a master device according to a communication protocol, the data being recorded in a memory belonging to the slave device, the method comprising a generation by the master device of a command provided by the communication protocol, and use of a field of the command in order to select an indirection register belonging to the slave device and containing an address of a region of the memory including the data.

According to one implementation, the communication protocol provides that the command field is intended to contain an address of a memory location on a first number of bits; the indirection register including a second number of bits greater than the first number to contain the address of the region of the memory including the data.

According to one implementation, the indirection register contains a base address and the size of the region of the memory containing the data.

For example, with registers of 32 bits for the base address and of 20 bits for the size of the region of the memory, the communicated data can be 1 MB in size located within the full extent of a 4 GB memory.

According to one implementation, the use of the command field includes:
a code, on the most significant bits of the field, to identify the indirection register which contains the address of the region of the memory containing the data, among several indirection registers of the slave device containing addresses of other respective regions of the memory; and
a quantification, on the least significant bits of the field, of an address offset positioning the start of the location of the data in the region.

According to one implementation, the command further includes the size of the data of the communication.

Thus, in these two implementations, the master device can precisely define in the command the start and end addresses (by the size of the location) of the memory data.

According to one implementation, the communication protocol follows the “Secure Digital Input Output—SDIO” communication standard defined by the “SD Association” group, and wherein the command is an extended block read/write command.

According to one implementation, the method further comprises another use of the command field in order to address a register of a function following the protocol, including a dedicated code on the most significant bits of the field to identify this other use.

According to another aspect, provision is also made of an integrated system including a slave device and a master device capable of communicating data therebetween according to a communication protocol, the data being recorded in a memory belonging to the slave device, the master device being configured to generate a command provided by the communication protocol, and to use a field of the command in order to select an indirection register belonging to the slave device and capable of containing an address of a region of the memory including the data.

According to one embodiment, the communication protocol provides that the command field is intended to contain an address of a memory location on a first number of bits; the indirection register being able to include a second number of bits greater than the first number to contain the address of the region of the memory including the data.

According to one embodiment, the indirection register is capable of containing a base address and the size of the region of the memory containing the data.

According to one embodiment, the master device is configured to use the command field by incorporating:
a code, on the most significant bits of the field, to identify the indirection register containing the address of the region of the memory containing the data, among several indirection registers of the slave device containing addresses of other respective regions of the memory; and
a quantification, on the least significant bits of the field, of an address offset positioning the start of the location of the data in the region.

According to one embodiment, the master device is configured to further incorporate into the command the size of the data of the communication.

According to one embodiment, the slave device and the master device are able to communicate data with each other according to the communication protocol following the “Secure Digital Input Output—SDIO” communication standard defined by the “SD Association” group.

According to one embodiment, the master device is further configured to otherwise use the command field in order to address a register of a function following the protocol, by incorporating a respectively dedicated code, on the most significant bits of the field, to identify this other use.

### BRIEF DESCRIPTION OF THE DRAWINGS

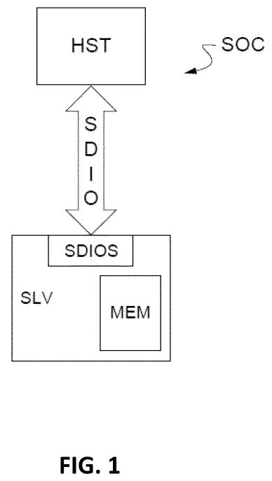

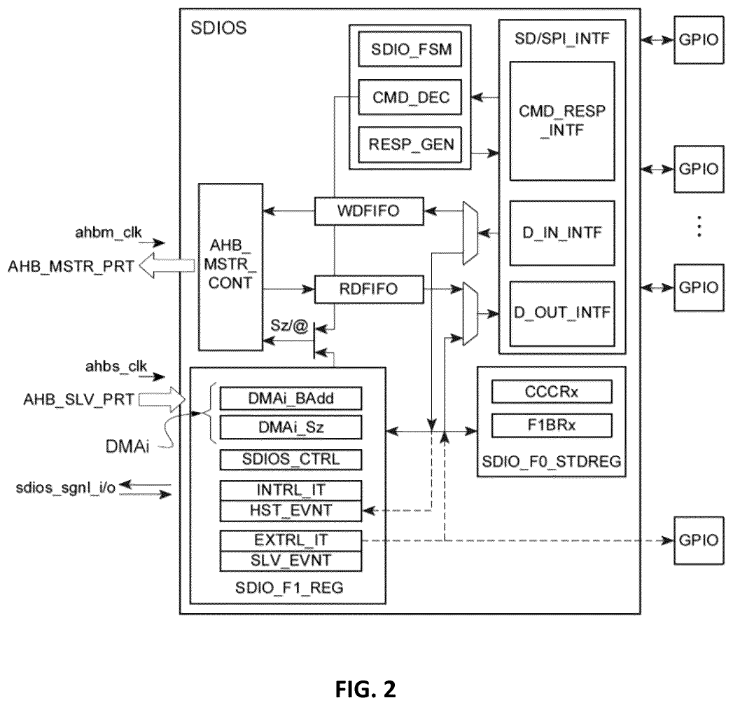

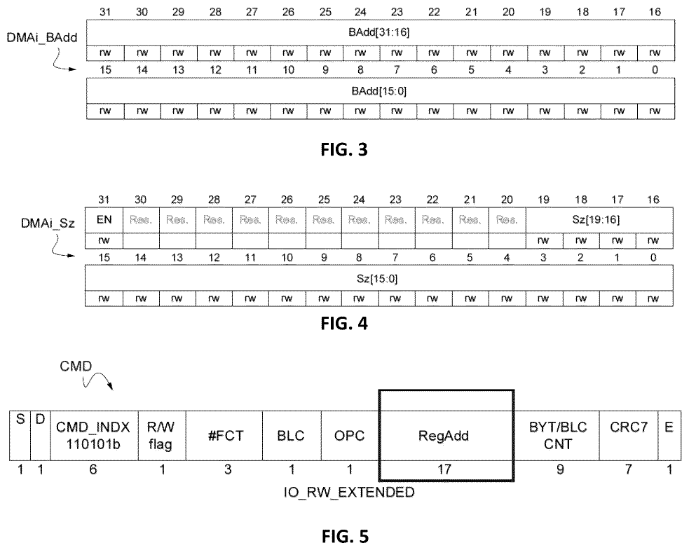

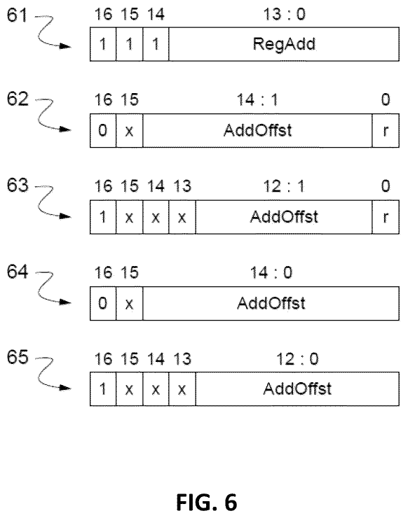

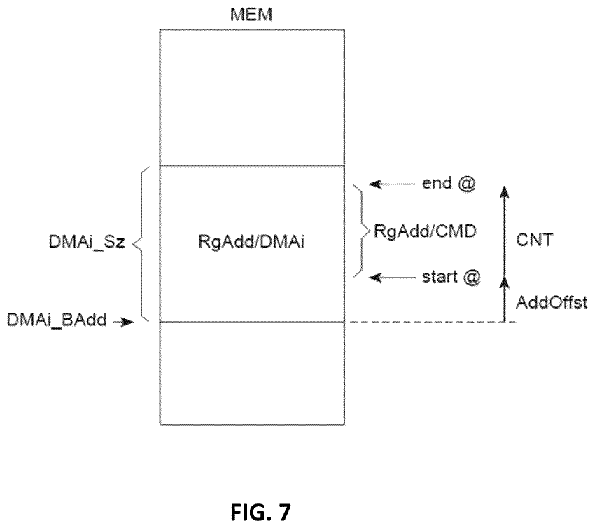

Other advantages and features of the present disclosure will appear upon examining the detailed description of implementations and embodiments, which is in no way limiting, and of the appended drawings wherein the figures:

[FIG. 1], [FIG. 2], [FIG. 3], [FIG. 4], [FIG. 5], [FIG. 6], and [FIG. 7] illustrate embodiments and implementations of the present disclosure.

### DETAILED DESCRIPTION

FIG. 1 illustrates an example of an integrated SOC system, such as a system on chip, including a master device HST, usually called a “host”, and a slave device SLV capable of communicating data with each other according to a communication protocol on an SDIO channel.

The master device HST is for example the application processor of the integrated system, while the slave device SLV is for example a peripheral providing the resources to implement a given functionality, for example a wireless communication functionality of the Wifi type.

The master device HST and the slave device SLV are for example produced on the same fully integrated silicon chip of the system-on-chip type, or according to separate chips connected to the same printed circuit board (usually “PCB”) in the integrated system.

The slave device SLV includes in particular an SDIOS slave interface adapted to the “Secure Digital Input Output” communication protocol defined by the standard established by the “SD Association” group, a memory MEM and an internal central unit adapted for the functionality.

The slave interface in particular and advantageously includes at least one indirection register DMAi (FIG. 2), intended to contain an address of a region of the memory MEM, which can be selected by the master device in an adapted command CMD (FIG. 5) of the communication protocol.

Indeed, the master device is advantageously configured to generate the command CMD (FIG. 5) provided by the communication protocol, adapted by the use of a field of the command RegAdd (FIG. 5) in order to select the indirection register DMAi of the slave device. Thus, the device can reach in the memory MEM the address contained in the indirection register DMAi, for example in the context of read or write data communication in the memory MEM.

FIG. 2 illustrates an exemplary embodiment of the SDIOS slave interface.

On the one hand, the SDIOS interface includes general-purpose input/output GPIO terminals, a bus interface SD/SPI_INTF compatible with the SDIO protocol (or even with other protocols, such as the serial data bus protocol “SPI” for “Serial Peripheral Interface”), including for example a command and response interface CMD_RESP_INTF, an input data interface D_IN_INTF, an output data interface D_OUT_INTF.

The bus interface SD/SPI_INTF can be commanded by a command unit which can include a state machine SDIO_FSM, a command decoder CMD_DEC, a response generator RESP_GEN, and communicate, via multiplexing circuits, with incoming WDFIFO and outgoing RDFIFO buffers from a master bus controller AHB_MSTR_CONT and with register banks SDIO_F0_STDREG, SDIO_F1_REG.

The master bus controller AHB_MSTR_CONT, for example a bus of the “AHB” type (for “Advanced High-performance Bus”), can for example generate communications to the internal central processing unit of the slave device SLV on a respective master bus port AHB_MSTR_PRT and receive a clock signal from the master bus ahbm_clk. Furthermore, slave AHB bus communications can be received on a slave bus port AHB_SLV_PRT as well as a slave bus clock signal ahbs_clk.

Other incoming and outgoing signals sdios_sgnl_i/o, which are of general-purpose and following the SDIO protocol, can be provided without being exhaustively detailed here.

On the other hand, a reserved bank of registers SDIO_F0_STDREG, and a first bank of registers SDIO_F1_REG are provided in the SDIOS slave interface.

The reserved bank of registers SDIO_F0_STDREG, in a manner imposed by the respective SDIO standard, includes the instructions CCCRx, F1BRx, allowing the implementation of the SDIO protocol. The SDIO protocol also allows seven other distinct functions in order to exploit the resources of the slave device SLV.

The first bank of registers SDIO_F1_REG allows to implement a first function of the slave device SLV. The first function may possibly be the only function of the SDIO protocol used by the slave device SLV. In other words, all resources of the slave device SLV can be accessed by implementing a single function of the SDIO protocol. This may for example be the case of a slave device SLV implementing wireless communications of the Wifi type.

The first bank of registers SDIO_F1_REG may include for example in this regard a control register SDIOS_CTRL, a register for internal interruption INTRNL_IT and for event notification to the host HST_EVNT, a register for external interruption EXTRNL_IT and for event notification to the peripheral SLV_EVNT.

The first bank SDIO_F1_REG further advantageously includes at least one indirection register DMAi capable of containing an address of a region of the memory MEM including data to be read or written upon command from the master device HST. An address, as such, typically allows a multiplet of bits to be identified in the memory, for example an 8-bit byte, depending on the granularity of the memory access. “Address of a memory region” means for example a start address of the region, as well as the size of the region, or alternatively an end address of the region. The indirection register DMAi is in this regard for example capable of containing a base address DMAi_BAdd and the size DMAi_Sz of the region of the memory containing the data.

FIG. 3 illustrates an example of a 32-bit register DMAi_BAdd belonging to one of the indirection registers DMAi to contain a base address of a region of the memory MEM.

Thus, on 32 bits, any address of a 4 GB (giga Byte) memory can be contained in the base address register DMAi_BAdd.

From the point of view of read and write access “rw”, the content of the base address register DMAi_BAdd can for example:
be write-accessed exclusively by the master device HST, and be read-accessed by the master device HST and by slave device SVL; or
be write and read-accessed exclusively by the slave device SLV.

FIG. 4 illustrates an example of a 32-bit register DMAi_BAdd belonging to one of the indirection registers DMAi, wherein 20 bits are allocated to quantify the size of the memory MEM region.

Thus, on 20 bits, sizes from 1 bit to 1 MB (mega Byte) can be contained in the region size register DMAi_Sz.

From the point of view of read and write access “rw”, the content of the region size register DMAi_Sz can for example be write-accessed exclusively by the master device HST, or exclusively by the slave device SLV; and, in both cases, be read-accessed by the master device HST and by the slave device SVL.

FIG. 5 illustrates a command CMD emitted by the master device HST, and provided by the communication protocol following the “Secure Digital Input Output” standard defined by the “SD Association” group, and which is for example and in particular an extended block read/write command.

A 6-bit field CMD_INDX is provided in order to communicate command index or identifier. In this example, the index 110101 in binary (53 in decimal) allows to identify the extended command (as opposed to the “direct command” of the protocol), allowing in particular reads/writes by bytes or by blocks, depending on the BLC bit.

A field of the command RegAdd is used in a manner provided for by the standard but nevertheless compatible with the standard, in order to select an indirection register DMAi belonging to the slave device and containing an address of a region of the memory MEM including the data.

The field of the command RegAdd is intended, in the communication protocol according to the standard, to contain an address of a memory location on a first number of bits less than the second number of bits communicating the address of the memory region in the indirection registers DMAi, DMAi_BAdd, DMAi_Sz. In the SDIO standard protocol, the field RegAdd includes 17 bits (first number), which is much smaller than the 32 bits (second number) of the base address register DMAi_BAdd.

The use of the field RegAdd of the command CMD can advantageously include a code on the most significant bits of the field, to identify the indirection register DMAi which contains the address of the region of the memory containing the data, among several indirection registers of the slave device containing addresses of other respective regions of the memory; and a quantification, on the least significant bits of the field, of an address offset AddOffst (FIG. 6) positioning the start of the location RgAdd/CMD (FIG. 7) of the data in the region RgAdd/DMAi (FIG. 7). Reference will in particular be made to FIG. 6.

Furthermore, the command CMD includes in a 9-bit field BYT/BLC CNT provided for this purpose, the number of data to be communicated (or transferred) with this command CMD, counted on a number of bytes (BYT) or blocks (BLC) of fixed size in a register which can be larger than one byte.

FIG. 6 illustrates an example of code on the most significant bits of the field RegAdd, allowing to select an indirection register DMAi from two indirection registers “DMA0”, “DMA1”, or from eight indirection registers “DMA0-7”. Each indirection register contains the addressing of different regions of the memory.

On the one hand, firstly 61, the code “111” can be provided on the three most significant bits 16, 15, 14 to identify a standard use of the field RegAdd, that is to say an addressing with the fourteen remaining least significant bits 13-0 of the registers SDIO_F1_REG of the first function, internal to the SDIOS slave interface peripheral.

On the other hand, in case 62, 64 of selection among two indirection registers, the codes “0x” (with x=0 or 1) can be provided on the two most significant bits 16, 15, to identify the respective indirection registers DMAi (i=[0;1]).

The quantification of the address offset AddOffst can be done on the remaining least significant bits 14:0, or 14:1 if the bit 0 is reserved “r”, for example in order to communicate an end of session; that is to say up to 64 kB (kilo Byte) or respectively 32 kB. This corresponds in particular to a technique of alignment in the middle of a memory word (usually “half-word aligned offset”).

In case 63, 65 of selection among eight indirection registers, the codes “1xxx” (with xxx=[000;001;010;011;100;101]) can be provided on the four most significant bits 16, 15, 14, 13 to identify the respective indirection registers DMAi (i=[2;3;4;5;6;7]). The registers DMA0, DMA1 can be identified in the same way as described previously “0x” in cases 62, 64.

The quantification of the address offset AddOffst can be done on the remaining least significant bits 12:0, or 12:1 if the bit 0 is reserved “r”, for example in order to communicate an end of session; that is to say up to 16 kB (kilo Byte) or respectively 8 kB. This again corresponds to a technique of alignment in the middle of a memory word (usually “half-word aligned offset”).

FIG. 7 illustrates the memory MEM of the slave device SLV, and in particular the method for accessing data contained in the memory MEM according to the technique using the command CMD and the indirection register DMAi as described previously in relation to the FIGS. 1 to 6.

The communication data RgAdd/CMD are located between a start address “start@” and an end address “end@”, in a memory region RgAdd/DMAi.

The content of the indirection register DMAi defines the address range of the memory region RgAdd/DMAi; in particular by a base address DMAi_BAdd in the base address register, and by a region size DMAi_Sz in the region size register.

The content of the command CMD, in addition to the identification code of the indirection register DMAi to be used, define the address range of the data of the communication RgAdd/CMD, positioning the start address start@ with the address offset AddOffst with respect to the base address BMAi_BAdd of the region, and the end address with the byte or block count CNT of the respective 9-bit field of the command CMD.

Thus, in summary, embodiments and implementations have been described, wherein the function 1 of the SDIO protocol allows to benefit from up to 8 “direct memory access” channels configured with indirection registers DMAi, for example to provide a 32-bit base address, and a 20-bit memory region size, offering 1 MB of data per channel over a 4 GB range of memory. The SDIO protocol particularly allows such transfers in multiple block mode, such as extended block read/write command. Access to the memory regions is further advantageously configurable by the host HST or by the peripheral SLV, while the communication data are finely positioned in the region by information in the content of the command CMD.

1. A method for communicating data between a slave device and a master device according to a communication protocol, the data being recorded in a memory belonging to the slave device, the method comprising:
generating, by the master device, a command provided by the communication protocol; and
using a field of the command in order to select an indirection register belonging to the slave device and containing an address of a region of the memory including the data.

2. The method of claim 1, wherein the communication protocol provides that the command field is intended to contain an address of a memory location on a first number of bits; and the indirection register including a second number of bits greater than the first number to contain the address of the region of the memory including the data.

3. The method of claim 2, wherein the indirection register contains a base address and a size of the region of the memory containing the data.

4. The method of claim 1, wherein using the field of the command includes:
a code, on one or more most significant bits of the field, to identify the indirection register which contains the address of the region of the memory containing the data, among several indirection registers of the slave device containing addresses of other respective regions of the memory; and
a quantification, on one or more least significant bits of the field, of an address offset positioning a start of the location of the data in the region.

5. The method of claim 4, wherein the command further includes a size of the data of a communication.

6. The method of claim 1, wherein the communication protocol follows a “Secure Digital Input Output—SDIO” communication standard defined by the “SD Association” group, and wherein the command is an extended block read/write command.

7. The method of claim 1, further comprising another using of the command field in order to address a register of a function following the protocol, including a respectively dedicated code on one or more most significant bits of the field to identify this other use.

8. An integrated system comprising a slave device and a master device capable of communicating data with each other according to a communication protocol, the data being recorded in a memory belonging to the slave device, the master device being configured to generate a command provided by the communication protocol, and to use a field of the command in order to select an indirection register belonging to the slave device and capable of containing an address of a region of the memory including the data.

9. The integrated system of claim 8, wherein the communication protocol provides that the command field is intended to contain an address of a memory location on a first number of bits; the indirection register being able to include a second number of bits greater than the first number to contain the address of the region of the memory including the data.

10. The integrated system of claim 9, wherein the indirection register is capable of containing a base address and a size of the region of the memory containing the data.

11. The integrated system of claim 8, wherein the master device is configured to use the command field by incorporating:
a code, on one or more most significant bits of the field, to identify the indirection register containing the address of the region of the memory containing the data, among several indirection registers of the slave device containing addresses of other respective regions of the memory; and
a quantification, on one or more least significant bits of the field, of an address offset positioning a start of the location of the data in the region.

12. The integrated system of claim 11, wherein the master device is configured to further incorporate into the command a size of the data of a communication.

13. The integrated system of claim 8, wherein the slave device and the master device are capable of communicating data with each other according to the communication protocol following a “Secure Digital Input Output—SDIO” communication standard defined by the “SD Association” group, the master device being configured to generate the command of the extended block read/write command type.

14. The integrated system of claim 8, wherein the master device is further configured to otherwise use the command field in order to address a register of a function following the protocol, by incorporating a respectively dedicated code, on one or more most significant bits of the field, to identify this other use.
